(19) United States
(12) Patent Application Publication
(10) Pub. No.: US 2026/0178098 A1
(43) Pub. Date: Jun. 25, 2026

(54) SYSTEMS AND METHODS FOR ASSISTING PLACEMENT OF ARTIFICIAL INTELLIGENCE WORKLOADS

(71) Applicant: Dell Products L.P., Round Rock, TX (US)

(72) Inventors: Jake M. LELAND, Round Rock, TX (US); Robert C. HERNANDEZ, Morrisville, NC (US)

(73) Assignee: Dell Products L.P., Round Rock, TX (US)

(21) Appl. No.: 18/991,853

(22) Filed: Dec. 23, 2024

(51) Int. Cl. G06F 1/3203

(52) U.S. Cl. CPC G06F 1/3203

(57) ABSTRACT

An information handling system may include a memory and a processor communicatively coupled to the memory, and configured to collect telemetry relating to execution of an artificial intelligence model on at least one configuration of a compute node and a quantization level, based on the telemetry collected, compute a power matrix setting forth average power consumption for execution of the artificial intelligence model on a plurality of configurations of compute nodes and quantization levels, and prioritize the plurality of configurations for execution of the artificial intelligence model based on the average power consumption for each configuration.

### TECHNICAL FIELD

The present disclosure relates in general to information handling systems, and more particularly to methods and systems for assisting in placement of artificial intelligence workloads across compute nodes.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

As advancements in artificial intelligence infrastructure continue to enable more client-friendly form factors, artificial intelligence model deployments are rapidly diversifying from cloud computing environments to edge computing environments. Artificial intelligence-enabled enterprises have increasingly more freedom to choose where their workloads run, often selecting local and edge deployments for the sake of cost and data protection. However, edge environments present unique challenges.

Power optimization of running systems is a key deliverable in many organizations'sustainability efforts. Doing so can decrease operating costs, increase profits, and decrease carbon emissions. Telemetry gathering utilities, running alongside workload orchestrators, may provide insights which may be used to organize workloads in a power optimal manner.

Artificial intelligence and machine learning workloads (i.e., models) have an added dimension over traditional workloads. They can be quantized to a smaller footprint which may allow additional workloads to be executed on the same processing node. Given an environment which has a mixture of artificial intelligence accelerators (e.g., central processing units, graphics processing units, neural processing units), if the models are migrated to the most power efficient choice, a measurable reduction in power consumption may be achieved.

Distributed workload orchestration services exist that are useful for managing generic workloads, but insufficient for managing artificial intelligence workloads efficiently for power consumption. Existing services may observe power usage during runtime but can only act on the workloads as static entities.

### SUMMARY

In accordance with the teachings of the present disclosure, the disadvantages and problems associated with existing approaches to deployment of artificial intelligence workloads may be reduced or eliminated.

In accordance with embodiments of the present disclosure, an information handling system may include a memory and a processor communicatively coupled to the memory, and configured to collect telemetry relating to execution of an artificial intelligence model on at least one configuration of a compute node and a quantization level, based on the telemetry collected, compute a power matrix setting forth average power consumption for execution of the artificial intelligence model on a plurality of configurations of compute nodes and quantization levels, and prioritize the plurality of configurations for execution of the artificial intelligence model based on the average power consumption for each configuration.

In accordance with these and other embodiments of the present disclosure, a method may include collecting telemetry relating to execution of an artificial intelligence model on at least one configuration of a compute node and a quantization level, based on the telemetry collected, computing a power matrix setting forth average power consumption for execution of the artificial intelligence model on a plurality of configurations of compute nodes and quantization levels, and prioritizing the plurality of configurations for execution of the artificial intelligence model based on the average power consumption for each configuration.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: collect telemetry relating to execution of an artificial intelligence model on at least one configuration of a compute node and a quantization level, based on the telemetry collected, compute a power matrix setting forth average power consumption for execution of the artificial intelligence model on a plurality of configurations of compute nodes and quantization levels, and prioritize the plurality of configurations for execution of the artificial intelligence model based on the average power consumption for each configuration.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIG. 2 illustrates a flow chart of an example method for assisting in placement of an artificial intelligence model to a compute node, in accordance with embodiments of the present disclosure;

FIG. 3 illustrates an example power matrix, in accordance with embodiments of the present disclosure; and

FIG. 4 illustrates an example timing diagram showing an example allocation of workloads across three compute nodes at two different times, in accordance with embodiments of the present disclosure.

### DETAILED DESCRIPTION

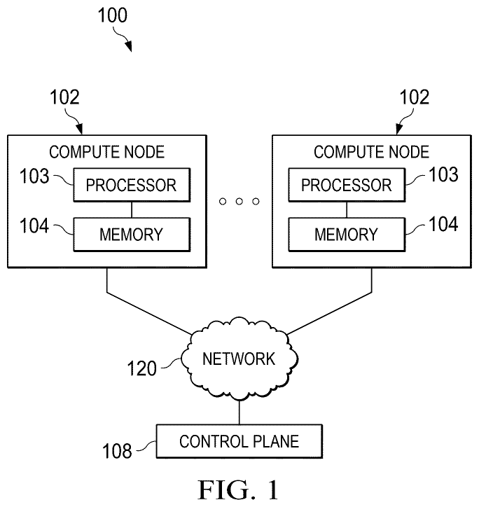

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may gather metrics for power consumption and throughput of workloads into heuristics to estimate power consumption across different accelerator types and by quantization levels. Control plane 108 may eliminate options for workload placement if such options are not viable, then sort remaining options based on optimal power placement. Control plane 108 may generate an output that ranks a compute node (i.e., accelerator) and quantization level combination for the workload in terms of power and may provide a cost to be incurred if an alternate combination is chosen. Such output may be used by an information technology decision maker or orchestrator to decide the ideal placement for workloads. Such output may also be used to schedule quantization tasks for workloads if a desired quantization does not already exist in a repository.

To further illustrate, control plane 108 may receive as input a model configuration of a model, user requests, and system telemetry for various compute nodes 102 of system 100. Model configuration may include any suitable configuration information for a model, such as its quantization level. User requests may include any requests of a user for executing the model, including user preferences, timestamps of requests, duration of requests, etc. System telemetry may include accelerator types (e.g., central processing unit, graphics processing unit, neural processing unit, etc.) of compute nodes 102, peak operations per second for the various compute nodes 102, thermal design power of the accelerators of compute nodes 102, utilization statistics of compute nodes 102, and power statistics of compute nodes 102.

Based on such inputs, as described in greater detail below, control plane 108 may generate outputs including model statistics per instance of a model and a placement recommendation of a compute node 102 for execution of a model. Model statistics may include a workload size, throughput, energy usage, and workload runtime power. A model recommendation may include a ranked list of most optimal deployments of a model to compute nodes 102, and suggestions for further optimizations in regards to model deployment.

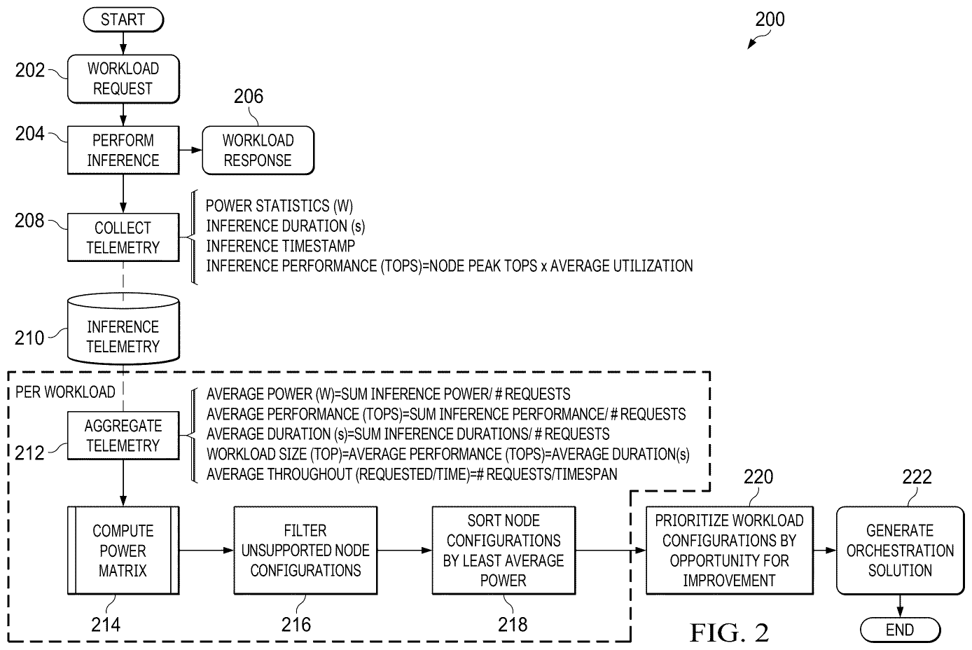

FIG. 2 illustrates a flow chart of an example method 200 for assisting in placement of an artificial intelligence model to a compute node, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, a user may issue a request for execution of an artificial intelligence workload. At step 204, a compute node 102 may execute the workload to perform an artificial intelligence inference, and at step 206, generate a workload response.

At step 208, during execution of the workload, control plane 108 may collect telemetry associated with such execution. Such telemetry may include, for example, power statistics associated with the execution, a duration of time for executing the inference, one or more timestamps associated with the execution, and performance of the execution of the inference (e.g., in terms of operations per second, which itself may be based on a peak operations per second for the compute node 102 executing the inference and average utilization of such compute node 102). At step 210, control plane 108 may store the collected telemetry in a database of inference telemetry for executed workloads.

At step 212, on a per workload basis, control plane 108 may aggregate telemetry collected for the given workload. For example, such aggregated telemetry may include an average power for execution of the workload, average performance of the workload, average duration of the workload, average size of the workload, and average throughput of the workload (e.g., requests per unit time).

At step 214, again on a per workload basis, control plane 108 may compute a power matrix setting forth the power consumption required to execute the workload on each of a plurality of compute nodes at various quantization levels. Accordingly, control plane 108 may loop through each compute node 102 and each accelerator on each compute node 102. For each accelerator, control plane 108 may determine if the accelerator supports execution of the model for the workload. If an accelerator does not support a model, such information may be logged by control plane 108 so that such accelerator is filtered out of the potential targets for execution of the workload. Otherwise, if an accelerator does support the model, control plane 108 may loop through various quantization levels for the model in order to generate the power matrix.

The power matrix may set forth for each accelerator and quantization level, an inference performance (e.g., in terms of trillions of operations per second), an inference power, an inference duration, an inference energy, and a workload average power.

For inference performance, if an average performance telemetry exists at the quantization level at issue for the accelerator, control plane 108 may use the telemetry data. Otherwise, if performance telemetry exists at multiple quantization levels, control plane 108 may interpolate between data points. Otherwise, if performance telemetry exists for the compute node 102, control plane 108 may estimate inference performance based on an inverse relationship to quantization. Otherwise, control plane 108 may estimate inference performance based on peak performance for the accelerator.

For inference power, if an average power telemetry exists at the quantization level at issue for the accelerator, control plane 108 may use the telemetry data. Otherwise, if power telemetry exists at multiple quantization levels, control plane 108 may interpolate between data points. Otherwise, if power telemetry exists for the compute node 102, control plane 108 may estimate inference power to be static. Otherwise, control plane 108 may estimate inference performance based on thermal design power for the accelerator.

For inference duration, if an average duration telemetry exists at the quantization level at issue for the accelerator, control plane 108 may use the telemetry data. Otherwise, if duration telemetry exists at multiple quantization levels, control plane 108 may interpolate between data points. Otherwise, control plane 108 may estimate inference duration based on workload size and inference performance (e.g., duration equals workload size divided by inference performance).

For inference energy, control plane 108 may multiply inference power by duration.

For workload average power, control plane 108 may multiply inference energy by throughput, wherein throughput is given as a rate per unit time.

Further, control plane 108 may determine if inference duration exceeds the inverse of throughput, and if duration exceeds the inverse of throughput for the combination of accelerator and quantization level, such information may be logged by control plane 108 so that such accelerator and quantization level is filtered out of the potential targets for execution of the workload.

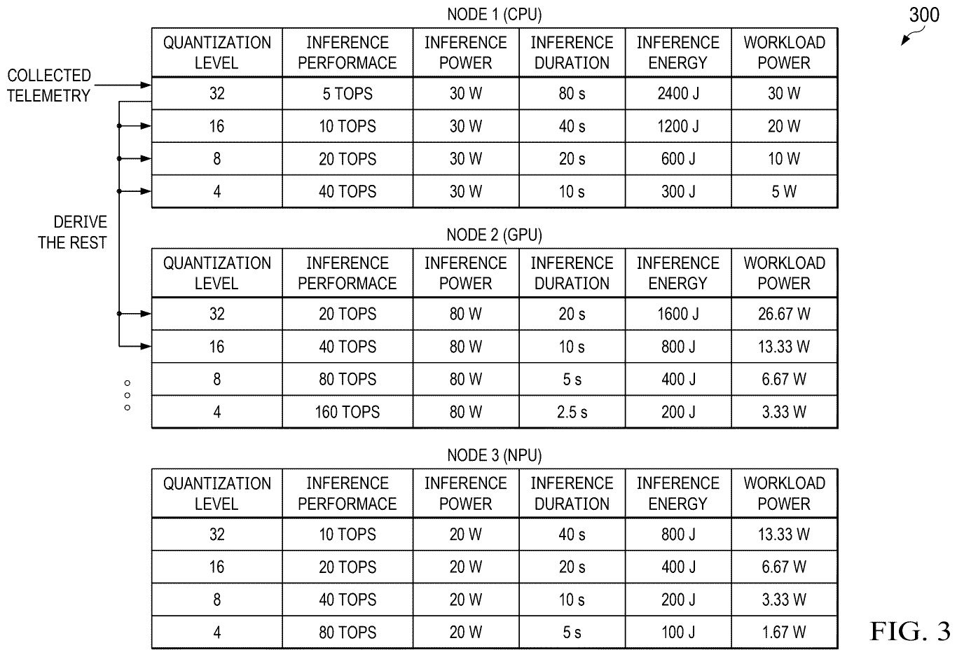

FIG. 3 illustrates an example power matrix 300 resulting from step 214, in accordance with embodiments of the present disclosure. FIG. 3 illustrates inference performance, inference power, inference duration, inference energy, and average workload power for a 400 trillion-operation inference request at one request per minute, across three difference compute nodes 102, at four different quantization levels at each compute node 102.

Turning again to FIG. 2, at step 216, control plane 108 may filter out node configurations which do not support the model. For example, in example power matrix 300, if control plane 108 determines that Node 3 (NPU) does not support the workload model, it may remove all configurations involving Node 3 (NPU) for possible placements of the workload.

At step 218, control plane 108 may sort the remaining node configurations by least average power. Thus, for example, looking at power matrix 300, control plane 108 may sort the remaining configurations of Node 1 (CPU) and Node 2 (GPU) in the following order:
1. Node 2 (GPU) at 4-bit quantization (3.33 W)
2. Node 1 (CPU) at 4-bit quantization (5 W)
3. Node 2 (GPU) at 8-bit quantization (6.67 W)
4. Node 1 (CPU) at 8-bit quantization (10 W)

. . .

At step 220, an orchestrator (which may in some embodiments be implemented by control plane 108) may receive the sorted list from the previous step, and prioritize workload configurations by opportunity for power improvement. In some embodiments, part of such orchestration may be removing items from the sorted list for which the orchestrator determines accuracy is too low. For example, the orchestrator may determine that 4-bit quantization accuracy is too low, and remove such configurations from the sorted list. Using the example of power matrix 300, removing the 4-bit quantization configurations from the list may result in the following order:
1. Node 2 (GPU) at 8-bit quantization (6.67 W)
2. Node 1 (CPU) at 8-bit quantization (10 W)
. . .

As a result, at step 222, the orchestrator may generate an orchestration solution with a determination of a recommended placement. For example, in the example of power matrix 300, the orchestrator may recommend migration of the execution of a workload from Node 1 (CPU) at a 32-bit quantization to Node 2 (GPU) at an 8-bit quantization, to provide a power improvement of 23.33 W for execution of the workload.

In some embodiments, the orchestration solution may also include further recommendations for power optimization. As an example, using the example of power matrix 300, the orchestrator may recommend enabling Node 3 (NPU) to support the workload, such that the workload could instead be migrated to Node 3 (NPU) at an 8-bit quantization to provide a power improvement of 26.67 W for execution of the workload.

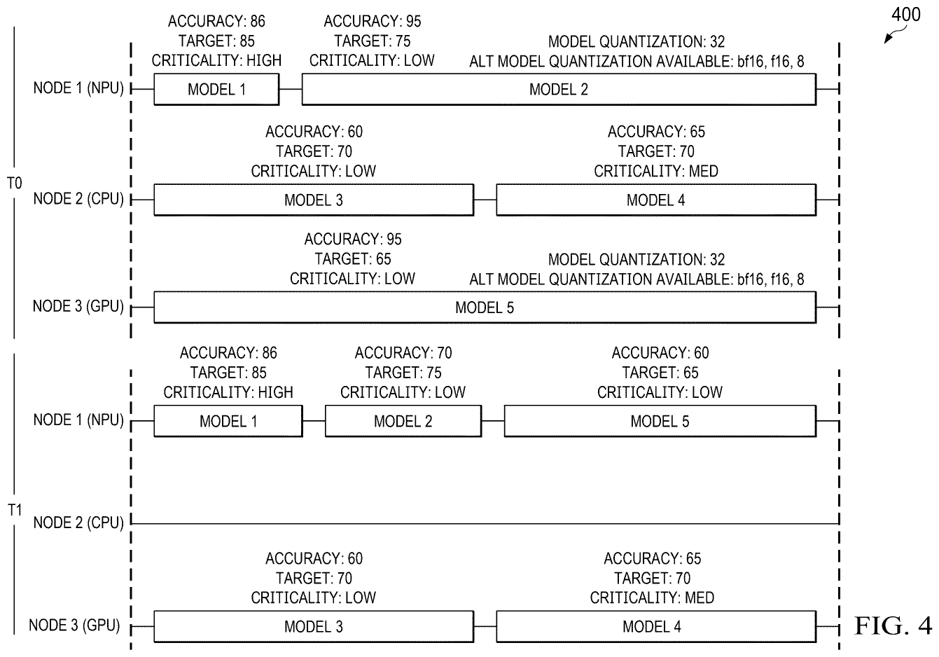

A further illustration of the potential advantage of the systems and methods described herein is shown in FIG. 4. FIG. 4 illustrates a timing diagram 400 showing an example allocation of workloads across three compute nodes at two different times, time T0 and time T1, in accordance with embodiments of the present disclosure. As shown in the example of FIG. 4, at time T0, all three compute nodes 102 are occupied, and models 3 and 4 suffer from low power efficiency on Node 2 (CPU). In accordance with the systems and methods described above, an orchestrator may observe that models 3 and 4 are suboptimal and observe that models 2 and 5 are exceeding target standards. Thus, the orchestrator may use quantized versions of models 2 and 5 to shrink their footprints, and condense models 2 and 5 onto Node 1 (NPU). The orchestrator may also reallocate models 3 and 4 to Node 3 (GPU) improving power efficiency. Node 2 (CPU) is now free, further improving power efficiency.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media.

In some embodiments, steps 212-222 may be triggered periodically by control plane 108, independent of the per-workload collection of telemetry by control plane 108.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
collect telemetry relating to execution of an artificial intelligence model on at least one configuration of a compute node and a quantization level;
based on the telemetry collected, compute a power matrix setting forth average power consumption for execution of the artificial intelligence model on a plurality of configurations of compute nodes and quantization levels; and
prioritize the plurality of configurations for execution of the artificial intelligence model based on the average power consumption for each configuration.

2. The information handling system of claim 1, wherein the telemetry collected comprises one or more of power statistics for execution of the artificial intelligence model, an inference duration of the artificial intelligence model, an inference performance of the artificial intelligence model, and an inference timestamp of the artificial intelligence model.

3. The information handling system of claim 1, wherein prioritizing the plurality of configurations for execution of the artificial intelligence model comprises filtering out configurations which are unsupported for execution of the artificial intelligence model.

4. The information handling system of claim 1, wherein prioritizing the plurality of configurations for execution of the artificial intelligence model comprises prioritizing only those of the plurality of configurations which satisfy accuracy requirements for execution of the artificial intelligence model.

5. A method comprising:
collecting telemetry relating to execution of an artificial intelligence model on at least one configuration of a compute node and a quantization level;
based on the telemetry collected, computing a power matrix setting forth average power consumption for execution of the artificial intelligence model on a plurality of configurations of compute nodes and quantization levels; and
prioritizing the plurality of configurations for execution of the artificial intelligence model based on the average power consumption for each configuration.

6. The method of claim 5, wherein the telemetry collected comprises one or more of power statistics for execution of the artificial intelligence model, an inference duration of the artificial intelligence model, an inference performance of the artificial intelligence model, and an inference timestamp of the artificial intelligence model.

7. The method of claim 5, wherein prioritizing the plurality of configurations for execution of the artificial intelligence model comprises filtering out configurations which are unsupported for execution of the artificial intelligence model.

8. The method of claim 5, wherein prioritizing the plurality of configurations for execution of the artificial intelligence model comprises prioritizing only those of the plurality of configurations which satisfy accuracy requirements for execution of the artificial intelligence model.

9. An article of manufacture comprising:
a non-transitory computer-readable medium; and
computer-executable instructions carried on the computer-readable medium, the instructions readable by a processor, the instructions, when read and executed, for causing the processor to:
collect telemetry relating to execution of an artificial intelligence model on at least one configuration of a compute node and a quantization level;
based on the telemetry collected, compute a power matrix setting forth average power consumption for execution of the artificial intelligence model on a plurality of configurations of compute nodes and quantization levels; and
prioritize the plurality of configurations for execution of the artificial intelligence model based on the average power consumption for each configuration.

10. The article of claim 9, wherein the telemetry collected comprises one or more of power statistics for execution of the artificial intelligence model, an inference duration of the artificial intelligence model, an inference performance of the artificial intelligence model, and an inference timestamp of the artificial intelligence model.

11. The article of claim 9, wherein prioritizing the plurality of configurations for execution of the artificial intelligence model comprises filtering out configurations which are unsupported for execution of the artificial intelligence model.

12. The article of claim 9, wherein prioritizing the plurality of configurations for execution of the artificial intelligence model comprises prioritizing only those of the plurality of configurations which satisfy accuracy requirements for execution of the artificial intelligence model.
